(19) United States
(12) Patent Application Publication
(10) Pub. No.: US 2011/0241560 A1
(43) Pub. Date: Oct. 6, 2011

(54) APPARATUS FOR GENERATING A DRIVE SIGNAL FOR A LAMP DEVICE AND METHOD FOR GENERATING A DRIVE SIGNAL FOR A LAMP DEVICE

(75) Inventor: Walter ENGLERT, Burgrieden (DE)

(73) Assignee: GLP GERMAN LIGHT PRODUCTS GMBH, Karlsbad (DE)

(21) Appl. No.: 12/752,452

(22) Filed: Apr. 1, 2010

(51) Int. Cl. H05B 41/30

(52) U.S. Cl. 315/287

(57) ABSTRACT

An apparatus for generating a drive signal for a lamp device comprises a pulse generator for generating a first pulse train in response to a first brightness request for a first brightness and for generating a second pulse train in response to a second brightness request for a second brightness. The first pulse train has a first frequency and the second pulse train has a different second frequency. The second pulse train comprises two neighboring pulses of the first pulse train and comprises a further pulse between the two neighboring pulses, the further pulse not being comprised in the first pulse train.

### FIELD OF THE INVENTION

The present invention relates to the field of generating drive signals, especially for lamp devices, such as LED spots.

### BACKGROUND OF THE INVENTION AND PRIOR ART

The adjustment of the brightness of an LED (light emitting diode) lightning device, such as an LED spot (for example, with a plurality of LEDs) is realized by a fast off and on switching of the LEDs. The higher the ratio between an on-state and an off-state of the LED is, the brighter the LED seems to light. If the frequency of the on and off switching is above 100 Hz, the human eye does not recognize the pulsing (the on and off switching) of the LEDs.

For cameras, especially for the new HDTV cameras, this on and off switching of the LEDs poses a problem. The pulsing of the LEDs leads to interferences with shutter-times and refresh-rates of the HDTV cameras. This can be recognized by a pulsing of the light in the camera.

A modulation signal for the on/off switching of LEDs is typically based on pulse-width modulation (PWM). To dim the LEDs, i.e. to adjust the brightness without visible jumps in the lightning curve, a high PWM ratio is desired. Typically, a ratio of 1:4096 is used. This relates to a resolution of 12 Bits.

If an LED spot (for example, with a plurality of LEDs) shall be applicable for modern TV cameras, like HDTV cameras, it is desired to have a PWM frequency as high as possible. Furthermore, this PWM frequency should be an integer multiple of 50 Hz and 60 Hz, otherwise, the LED spot cannot be used world-wide. As mentioned before, in the case of the TV cameras, not only the refresh rate, but also the shutter time is of importance. The shutter time of a TV camera defines how long a shutter of the TV camera is opened to acquire one picture. If this mentioned shutter time is very short, then a very high PWM frequency is desired. It has been found that a PWM frequency of 600 Hz is sufficient, but a PWM frequency of 1200 Hz or 2400 Hz offers a safety distance to obtain a picture without pulsing and jittering also in ambient lightning conditions.

This leads to a shortest pulse length t_{on min} of a PWM signal for an LED or an LED spot based on the following equation:

$$\begin{matrix}{t}_{on min} = 1 / ( {f}_{camera} * PWM \text{-} ratio ) \\ = 1 / ( 2400 Hz * 4096 )\end{matrix} \\ {t}_{on min} = 0 , 1017 us \qquad ( 1 )$$

For a typical microcontroller with a typical instruction time of 100 ns (which corresponds to a frequency of 10 Mz), this time is much too short to output impulses of this length. Furthermore, one microcontroller should be used to control a plurality of LEDs to save costs and effort. Therefore, a typical microcontroller cannot be used for providing a signal to drive an LED or a plurality of LEDs of an LED spot, which fulfils all the above-mentioned requirements for modern HDTV cameras. One possibility would be to use high-sophisticated digital signal processing processors, but which would result in a dramatically increase of costs and effort.

An object of the present invention is to provide a concept allowing to drive an LED or an LED spot for an HDTV camera with lower requirements to a drive signal generator for the LED or the LED spot than in the prior art.

### SUMMARY OF THE INVENTION

This object is attained in accordance with an apparatus according to claim 1, an apparatus according to claim 12, a method according to claim 19, a method according to claim 20 and a computer program according to claim 21.

It is the central idea of the invention that a first drive signal for a first brightness for a lamp device differs from a second drive signal for a second brightness for the lamp device by a frequency or, in other words, by a number of pulses the drive signals contain in a certain amount of time. It has been found that by changing the frequency of the drive signals for a change in brightness, instead of keeping the frequency constant and changing the length of the pulses of the drive signals for changing the brightness, as this is done in PWM, the individual pulses of the drive signals can be made longer than in the conventional PWM. Therefore, a conventional microcontroller and especially a low-cost microcontroller can be used for generating a drive signal for a lamp device, such as an LED or an LED spot.

An advantage of the present invention is, therefore, that by changing the frequency to adjust the brightness of a light device, instead of changing the length of pulses and keeping the frequency constant, cheaper and easier devices for generating a drive signal for a lamp device or an LED or an LED spot can be used as this is known in the prior art.

Some embodiments of the present invention provide an apparatus for generating a drive signal for a lamp device. The apparatus comprises a pulse generator for generating a first pulse train in response to a first brightness request for a first brightness and for generating a second pulse train in response to a second brightness request for a second brightness. The first pulse train has a first frequency and the second pulse train has a second frequency, wherein the first frequency is different from the second frequency. The second pulse train comprises two neighboring pulses of the first pulse train and a further pulse between the two neighboring pulses, the further pulse not being comprised in the first pulse train.

According to some embodiments, the pulse generator may be configured to generate the first and the second pulse trains such that a pulse length of the two neighboring pulses and of the further pulse is identical. In other words, the pulse generator may be configured to change a brightness of the lamp device by adding or removing pulses of an equidistant length. In a conventional PWM system, the frequency of the drive signal is constant and a change of brightness is attained by changing the on/off ratio of the pulses. In other words, in a conventional PWM system, different drive signals for different degrees of brightness differ only by the on/off ratio of the pulses (and therefore by the length of the pulses) and not by the frequency of the drive signal itself.

According to some embodiments, the second brightness may be brighter than the first brightness, for example, if a pulse is a current pulse provided to the lamp device.

According to some further embodiments, the apparatus may further comprise a brightness request generator, which is configured to provide at least a first and a second brightness request to an input terminal of the pulse generator. The pulse generator may, for example, receive the first and the second brightness request at the input terminal and may output a drive signal with a corresponding pulse train, for example, depending on an internal look-up table.

Other elements, features, steps, characteristics and advantages of the present invention will become more apparent from the following detailed description of the preferred embodiments with reference to the attached drawings.

### BRIEF DESCRIPTION OF THE DRAWINGS

Embodiments of the present invention will be explained below in more detail with reference to the accompanying Figs., wherein:

FIG. 1a shows an apparatus according to an embodiment of the present invention coupled to a lamp device;

FIG. 1b shows two diagrams of pulse trains generated by a pulse generator of the apparatus shown in FIG. 1a;

FIG. 2 shows diagrams of the two pulse trains shown in FIG. 1b and of corresponding PWM signals;

FIG. 3a shows a block diagram of an apparatus according to an embodiment of the present invention coupled to a lamp device;

FIG. 3b shows two diagrams of pulse trains generated by a pulse generator of the apparatus shown in FIG. 3a;

FIG. 4 shows diagrams of the two pulse trains shown in FIG. 3b and of corresponding PWM signals;

FIG. 5 shows an apparatus according to an embodiment of the present invention coupled to a lamp device;

FIGS. 6a to 6d show diagrams of pulse trains generated by pulse generators of apparatuses according to embodiments of the present invention;

FIG. 7 shows a flow diagram of a method according to an embodiment of the present invention; and

FIG. 8 shows a flow diagram of a method according to an embodiment of the present invention.

### DETAILED DESCRIPTION OF THE PREFERRED EMBODIMENTS

Before embodiments of the present invention will be explained in greater detail in the following on the basis of the Figs., it is to be pointed out that the same or functionally equal elements are provided with the same reference numerals in the Figs. and that a repeated description of these elements shall be omitted. Hence, the description of the elements provided with the same reference numerals is mutually interchangeable and/or applicable in the various embodiments.

A pulse length may in the following also be called as a pulse time or as a temporal extension of the pulse.

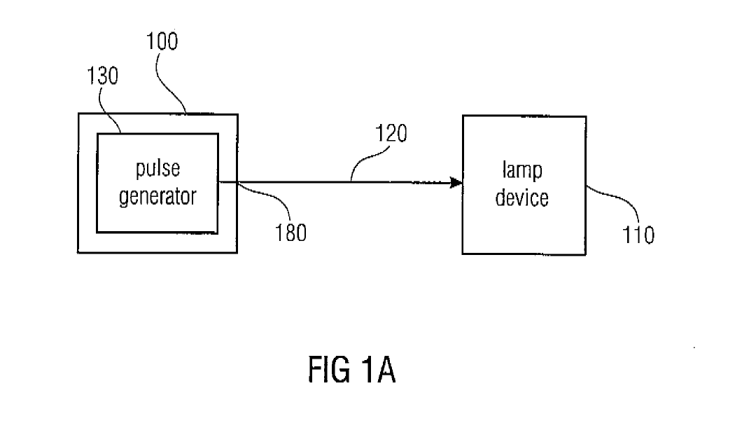

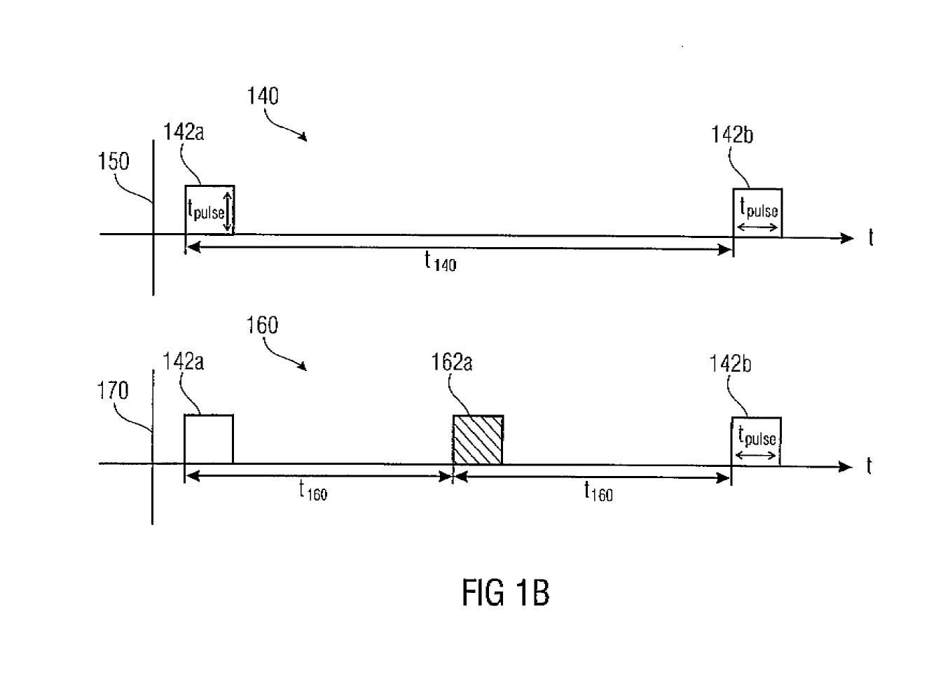

FIG. 1a shows a block diagram of an apparatus 100 according to an embodiment of the present invention coupled to a lamp device 110. The apparatus 100 for generating a drive signal 120 for the lamp device 110 comprises a pulse generator 130. The pulse generator 130 is configured to generate a first pulse train 140 (shown in FIG. 1b) and to generate a second pulse train 160 (shown in FIG. 1b). The first pulse train 140 and the second pulse train 160 may be provided at an output terminal 180 of the apparatus 100 and may as a continuous stream create the drive signal 120, wherein a drive signal 120 based on the first pulse train 140 would result in another brightness of the lamp device 110 than a drive signal 120 based on the second pulse train 160. The pulse generator 130 is configured to generate the first pulse train 140 in response to a first brightness request for a first brightness and to generate the second pulse train 160 in response to a second brightness request for a second brightness. The first pulse train 140 has a frequency f₁₄₀, which is different to a frequency f₁₆₀ of the second pulse train 160. Therefore, the first brightness may be different from the second brightness, for example, the first brightness may be higher than the second brightness.

FIG. 1b shows a schematic diagram 150 of the first pulse train 140 and a schematic diagram 170 of the second pulse train 160 The first pulse train 140 comprises at least a first pulse 142a and a second pulse 142b. The first pulse 142a and the second pulse 142b are neighboring pulses, which means the second pulse 142b follows the first pulse 142a in time and no other pulse is arranged between these two neighboring pulses 142a, 142b. Therefore, the period of the pulse train 140 may be a time t₁₄₀ between the first pulse 142a and the second pulse 142b. The frequency f₁₄₀ may then be f₁₄₀=1/t₁₄₀.

The second pulse train 160 comprises the two neighboring pulses 142a, 142b of the first pulse train 140 and a further pulse 162a between the two neighboring pulses 142a and 142b. The further pulse 162a is not comprised nor contained in the first pulse train 140. Because of the temporal arrangement of the further pulse 162a between the two neighboring pulses 142a, 142b a second time t₁₆₀ between two temporally-subsequent pulses of the second pulse train 160 is shorter than the first time t₁₄₀ (between the two neighboring pulses 142a, 142b) of the first pulse train 140. In other words, a first time t₁₆₀ between a rising edge of the first neighboring pulse 142a and a rising edge of the temporally-following further pulse 162a is shorter than the first time t₁₄₀ between the rising edge of the first neighboring pulse 142a and the rising edge of the second neighboring pulse 142b of the first pulse train 140. Therefore, a frequency f₁₆₀ of the second pulse train 160 is higher than a frequency f₁₄₀ of the first pulse train 140. In addition, the further pulse 162a is temporally arranged between the two neighboring pulses 142a, 142b such that a time between the rising edge of the first neighboring pulse 142a and the rising edge of the further pulse 162a is the same, like a time between the rising edge of the further pulse 162a and a rising edge of the second neighboring pulse 142b. In further embodiments, the further pulse 162a could also be arranged in a temporally-arbitrary position between the two neighboring pulses 142a, 142b. In the concrete embodiment shown in FIG. 1b, the frequency f₁₆₀ of the second pulse train 160 is double the amount of the frequency f₁₄₀ of the first pulse train 140. Therefore, a brightness of the lamp device 110 may be higher when the second pulse train 160 is provided as the drive signal 120 to the lamp device 110 than when the first pulse train 140 is provided as a drive signal 120 to the lamp device 110. An amplitude Iₚᵤₗₛₑ of the pulses of the first pulse train 140 and the second pulse train 160 may, for example, represent a current flowing through the lamp device 110. Hence, by applying the second pulse train 160 as a drive signal 120, the lamp device 110 is switched on more often at the same time (for example, the time t₁₄₀) than when the first pulse train 140 is applied as a drive signal 120. This leads to a longer on-time of the lamp device 110 per time unit and, therefore, to a brighter light impression for a human eye. The time unit in which the lamp device 110 is switched on and off is chosen such that the human eye is not able to see the on/off switching of the lamp device 110.

According to some embodiments, a pulse length tₚᵤₗₛₑ or of the two neighboring pulses 142a, 142b and the further pulse 162a may be identical. Furthermore, the first time t₁₄₀ and the second time t₁₆₀ may be a multiple of the pulse length tₚᵤₗₛₑ.

According to some embodiments, a temporal extension of the first pulse train 140 and a temporal extension of the second pulse train 160 may be identical, as is shown in FIG. 1b. In FIG. 1b, the temporal extension of the first pulse train 140 is the first time t₁₄₀ and a temporal extension of the second pulse train 160 is twice the second time t₁₆₀, wherein the second time t₁₆₀ is half of the first time t₁₄₀.

According to further embodiments, the drive signal 120 may comprise a plurality of first pulse trains 140 or second pulse trains 160. For the first brightness, the drive signal 120 would, for example, be a continuous stream of pulse trains 140 and for the second brightness, the drive signal 120 would be a continuous stream of the pulse trains 160. In a drive signal 120 based on the first pulse trains 140, a time between two rising edges of two temporally subsequent pulses would be the first time t₁₄₀. In a drive signal 120 based on the second pulse trains 160, a time between two rising edges of two temporally subsequent pulses would be the second time t₁₆₀.

According to further embodiments a time between two rising edges of subsequent following pulses of a pulse train may vary within in the pulse train, therefore a time between two rising edges of pulses of the pulse train may be different for different subsequent following pulses of the pulse train.

According to further embodiments, the pulse generator 130 may be further configured to generate a plurality of pulse trains in response to a plurality of different brightness requests, such that a pulse train out of the plurality of pulse trains corresponds to a brightness request out of the plurality of brightness requests. Different pulse trains may differ from each other by the number of pulses they comprise. As mentioned before, a temporal extension of the different pulse trains may be identical for all pulse trains.

According to further embodiments, the pulse train generator 130 may comprise a microcontroller, which is configured to provide the drive signal 120 or a plurality of drive signals 120 at an output terminal or at a plurality of output terminals. An output terminal of the microcontroller may, for example, be an I/O pin of the microcontroller. The I/O pin of the microcontroller may be coupled to the lamp device 110, by directly connecting the lamp device 110 to the I/O pin, or with a lamp device driver, which provides a drive current for the lamp device 110, between the I/O pin and the lamp device 110.

According to further embodiments, the lamp device 110 may comprise an LED or a plurality of LEDs or any other lightning devices. A lamp device 110 comprising a plurality of lightning devices or LEDs may therefore comprise a plurality of input terminals for the plurality of drive signals 120, such that degrees of brightness of the different LEDs or lightning devices of the lamp device 110 can differ from each other. In particular, the different LEDs or lightning devices of the lamp device 110 may comprise different colors, for example, an LED or a lightning device for red, an LED or a lightning device for green and an LED or a lightning device for blue. In other words, the lamp device 110 may be an RGB lamp device.

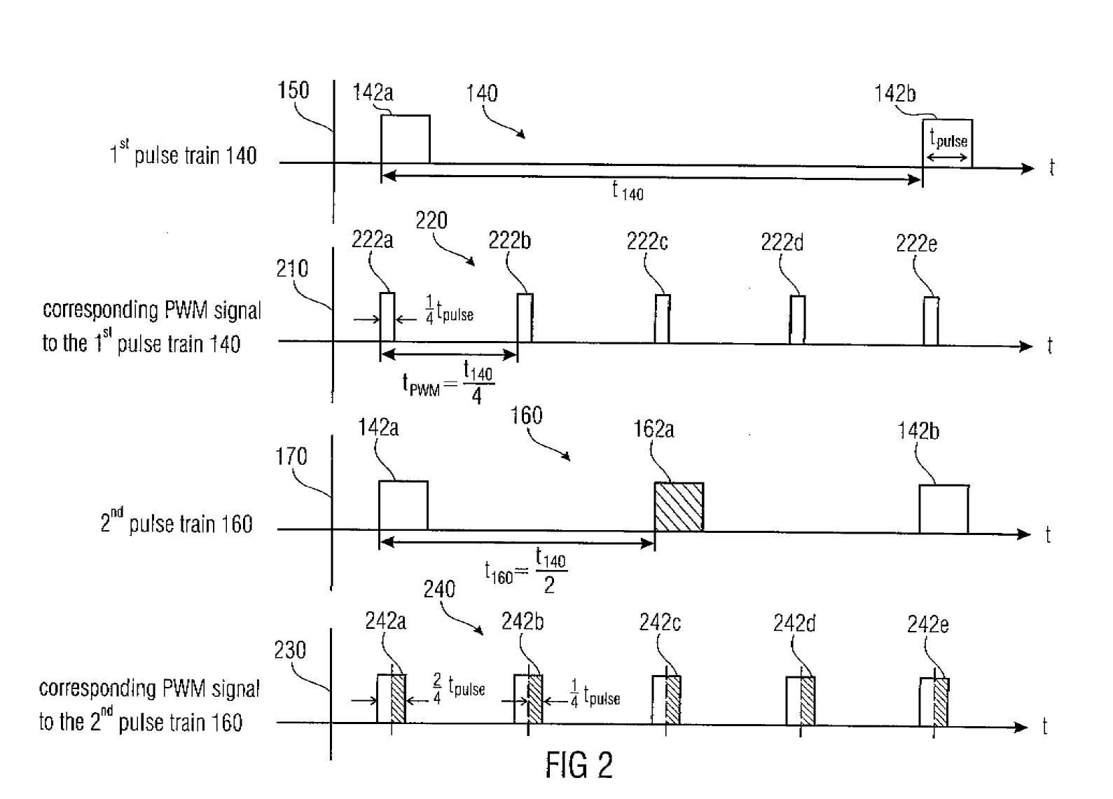

FIG. 2 shows the schematic diagram 150 of the first pulse train 140 from FIG. 1 and a schematic diagram 210 of a corresponding PWM signal 220. Furthermore, FIG. 2 shows the schematic diagram 170 of the second pulse train 160 from FIG. 1b and a schematic diagram 230 of a corresponding PWM signal 240. The first PWM signal 220 corresponds to the first pulse train 140, because a sum of pulse durations of pulses of the first PWM signal 220 in a given time interval (for example, the time interval t₁₄₀) is equal to the sum of pulse durations of pulses of the first pulse train 140 in the given time interval. Analogously, the second PWM signal 240 corresponds to the second pulse train 160, because the sum of pulse durations of pulses of the second PWM signal 240 in the given time interval is equal to a sum of pulse durations of pulses of the second pulses train 160 in the given time interval. In other words, a first number of charge carriers flowing into the lamp device 110 in the time interval t₁₄₀ is the same when the drive signal 120 is based on the first pulse train 240 or on the second PWM signal 220 and a second number of charge carriers flowing into the lamp device 110 is the same when the drive signal 120 is based on the second pulse train 160 or on the second PWM signal 240. Therefore, the first brightness corresponding to the first pulse train 140 also corresponds to the first PWM signal 220 and the second brightness corresponding to the second pulse train 160 also corresponds to the second PWM signal 240.

The first PWM signal 210 comprises four pulses 222a, 222b, 222c, 222d in the time interval t₁₄₀ between the two neighboring pulses 142a and 142b of the first pulse train 140. A time interval t_{PWM} between two rising edges of neighboring pulses of the second PWM signal 220 is a quarter of t₁₄₀ (t₁₄₀/4). A frequency f_{PWM} of the first PWM signal 220 is, therefore, four times higher than the frequency f₁₄₀ of the first pulse train 140. A drawback of the conventional PWM is that the frequency for a conventional PWM drive signal stays constant for every brightness request. Therefore, a minimum pulse duration of a PWM signal has to be much shorter than in embodiments of the present invention, wherein drive signals 120 for different brightness requests differ by frequency. In the concrete embodiment shown in FIG. 2, a pulse length of the pulses 222a to 222d of the first PWM signal 220 is one-fourth of the pulse length tₚᵤₗₛₑ of the pulses 142a, 142b of the first pulse train 140. Therefore, a pulse generator generating the second PWM signal 220 has to be at least four times faster than a pulse generator 130 for generating the first pulse train 140. Especially in low degrees of brightness, a low frequency of the first pulse train 140 compared to the second PWM signal 220 is not a problem, because TV cameras only react in a sensitive manner to low frequencies of the pulsing of the lamp device 110 with higher brightness (for example, half of the maximum brightness of the lamp device 110). In embodiments of the present invention, a brightness of the lamp device 110 is increased by raising the frequency of the drive signal 120, for example, a frequency of the drive signal 120 may be the highest when the TV camera is most sensitive to a pulsing of the lamp device 110. For example, the frequency of the drive signal 120 in a most sensitive region of a TV camera may be the same or even higher than a frequency of a corresponding PWM signal.

As mentioned before, in an embodiment of the present invention, a brightness of the lamp device 110 is raised by raising the frequency of the drive signal 120. Therefore, the frequency f₁₆₀ of the second pulse train 160 is higher than the frequency f₁₄₀ of the first pulse train 140 and, therefore, the frequency of the drive signal 120 is higher when the drive signal 120 is based on the second pulse train 160 than on the first pulse train 140. In contrast to this, the second PWM signal 240, which corresponds to the second pulse train 160, has the same frequency f_{PWM} as the first PWM signal 220. This is a typical property of conventional PWM signals, wherein different degrees of brightness would be obtained by different lengths of the pulses of the PWM signal, while the frequency of the PWM signal would be kept constant. As mentioned before, a drawback of these conventional PWM signals is that, therefore, pulse lengths of the pulses of the conventional PWM signal have to be kept much shorter than in embodiments of the present invention, wherein different degrees of brightness correspond to different frequencies of the drive signal 120.

In FIG. 2, hatched lines in the pulses mark the changes from the first pulse train 140 to the second pulse train 160 and from the first PWM signal 220 to the second PWM signal 240. By having the further pulse 162a between the two neighboring pulses 142a, 142b in the second pulse train 160, more charge carriers flow into the lamp device 110 when the drive signal 120 is based on the second pulse train 160 than on the first pulse train 140. In a conventional PWM signal, the length of the pulses of the PWM signal would be extended to obtain more charge carriers flowing into the lamp device. This is shown in FIG. 2, wherein the pulses 242a, 242b, 242c, 242d of the second PWM signal 240 are longer than the pulses 222a, 222b, 222c, 222d of the PWM signal 220. In the concrete embodiment shown in FIG. 2, a pulse length of the pulses 242a to 242d is half the pulse length tₚᵤₗₛₑ of the pulses 142a, 162a, 142b of the second pulse train 160. The pulse length tₚᵤₗₛₑ of the pulses of the second pulse train 160 is identical with the pulse length tₚᵤₗₛₑ of the pulses of the first pulse train 140. Due to the shorter duration of the pulses of the second PWM signal 240, a pulse generator for the second PWM signal 240, for example, a microcontroller would still have to be at least double as fast as the pulse generator 130 for generating the second pulse train 160.

For a further increase in the brightness of the lamp device 110, a further pulse may be added between the two neighboring pulses 142a, 142b, wherein with each increase of brightness of the lamp device 110, the frequency of the drive signal 120 would be increased, too. Therefore, a drive signal 120 generated by the pulse generator 130 may have the same or even a higher frequency than a corresponding PWM signal for the same brightness of the lamp device 110. The pulse generator 130 may be configured such that a frequency of the drive signal 120 is the highest, when a sensitivity of a TV camera used in conjunction with a lamp device 110 is the highest in regards of a pulsing of the lamp device 110. In particular, the pulse generator 130 may be a conventional microcontroller with a comparatively low instruction cycle time compared to a pulse generator needed for generating a drive signal based on a conventional PWM signal and fulfilling the requirements of a TV camera used in conjunction with the lamp device 110. As it can be seen from FIG. 2, the pulse generator 130 for generating the first pulse train 140 and the second pulse train 160 may be four times slower than a pulse generator for generating the first PWM signal 220 and the second PWM signal 240. Thus, the pulse generator 130 may be significantly cheaper and/or may be used to control a plurality of lamp devices 110 compared to the conventional pulse generator for generating the first PWM signal 220 and the second PWM signal 240.

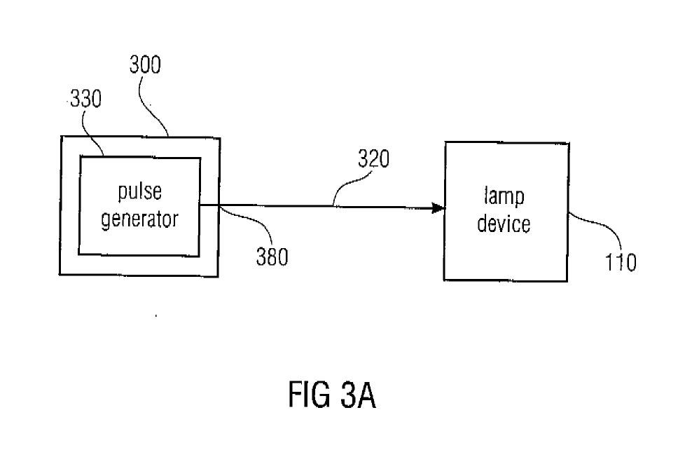

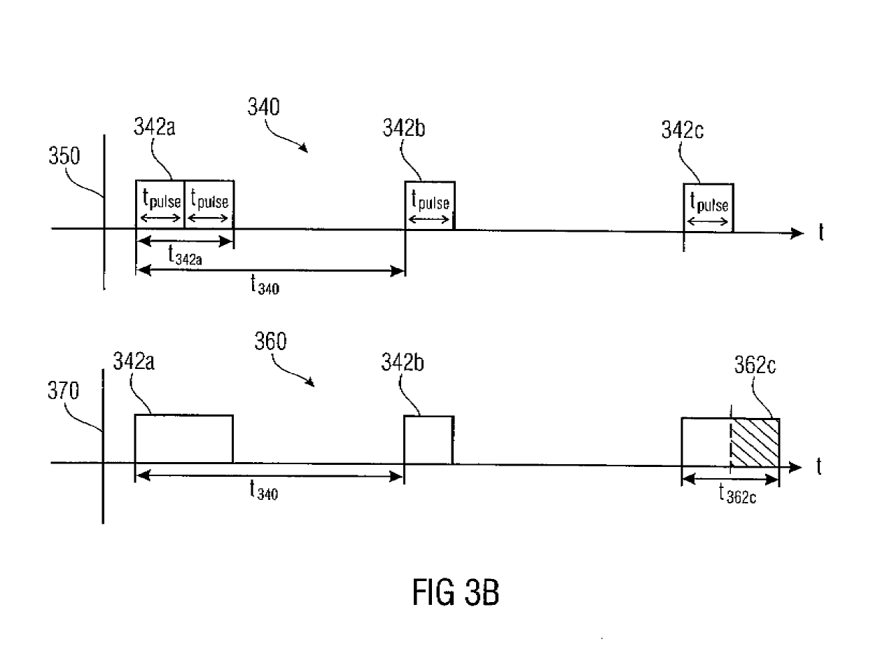

FIG. 3a shows a schematic block diagram of an apparatus 300 for generating a drive signal 320 for a lamp device 110. The apparatus 300 comprises a pulse generator 330 for generating a first pulse train 340 in response to a first brightness request for a first brightness and for generating a second pulse train 360 in response to a second brightness request for a second brightness. The first pulse train 340 (shown in FIG. 3b) has at least three individual pulses. The second pulse train 360 (shown in FIG. 3b) has at least three individual pulses, wherein less than all of the said at least three individual pulses have the same length. At least one of the at least three individual pulses of the second pulse train 360 has a different length compared to the corresponding individual pulse in the first pulse train 340.

The pulse generator may, for example, be a microcontroller (for example, directly connected or with a lamp driver in-between) coupled to the lamp device 110. The drive signal 320 may be based on a continuous stream of first pulse trains 340 or on a continuous stream of second pulse trains 360, dependent on a brightness request. A drive signal 320, which is based on the first pulse train 340 may lead to a different brightness of the lamp device 110 than a drive signal 320 based on the second pulse train 360. For example, a brightness of the lamp device 110 may be higher or larger when a drive signal 320 based on the second pulse train 360 is applied to the lamp device 110 than when a drive signal 320 based on the first pulse train 340 is applied to the lamp device 110. Therefore, the second brightness may be higher than the first brightness.

FIG. 3b shows a schematic diagram 350 of the first pulse train 340 and a schematic diagram 370 of the second pulse train 360. The first pulse train 340 comprises a first pulse 342a, a second pulse 342b and a third pulse 342c. A temporal extension t₃₄₂ₐ of the first pulse train 342a is twice the temporal extension tₚᵤₗₛₑ of the pulse 342b and the pulse 342c. The three individual pulses 342a, 342b, 342c are individual, because the first pulse train 340 not comprises any pulses between two neighboring pulses of the three individual pulses 342a, 342b, 342c. In other words, if an amplitude of the three individual pulses 342, 342b, 342c is a current flowing into the lamp device 110 between the three individual pulses 342a, 342b, 342c, i.e. between a falling edge of one of the three individual pulses 342a, 342b, 342c and a rising edge of a temporally-following pulse of the three individual pulses 342a, 342b, 342c, no current flows into the lamp device 110.

The second pulse train 360 comprises three individual pulses 342a, 342b, 362c (from the first pulse train 340). A temporal extension t_{362c} or a pulse length of the third pulse 362c of the three individual pulses 342a, 342b, 362a of the second pulse train 360 differs from the pulse length tₚᵤₗₛₑ of its corresponding pulse 342c of the first pulse train 340. The pulse length of the other two individual pulses 342a, 342b of the second pulse train 360 is identical to the pulse length of the corresponding individual pulses in the first pulse train 340. In the concrete embodiment shown in FIG. 3b, the pulse length t_{362c} of the third pulse 362c of the second pulse train 360 is one pulse length interval tₚᵤₗₛₑ longer than the pulse length tₚᵤₗₛₑ of the third pulse 342c of the first pulse train 340.

According to further embodiments, the time tₚᵤₗₛₑ may be the smallest possible pulse length, wherein pulse lengths of all pulses of pulse trains generated by the pulse generator 330 may be at least the smallest pulse length tₚᵤₗₛₑ or a multiple of the smallest pulse length tₚᵤₗₛₑ.

According to further embodiments, the pulse length of a pulse of a pulse train may differ to a pulse length of another pulse of the same pulse train at maximum by the smallest pulse length tₚᵤₗₛₑ.

According to further embodiments, the time between two rising edges of pulses of a pulse train may be a multiple of the smallest pulse length tₚᵤₗₛₑ.

As it can be seen in FIG. 3b, an increase in the brightness of the lamp device 110 can be obtained with a pulse generator 330 by extending a pulse length of a pulse of a pulse train generated by the pulse generator 330. A frequency of different pulse trains corresponding to different degrees of brightness of the lamp device 110 may be the same for all pulse trains.

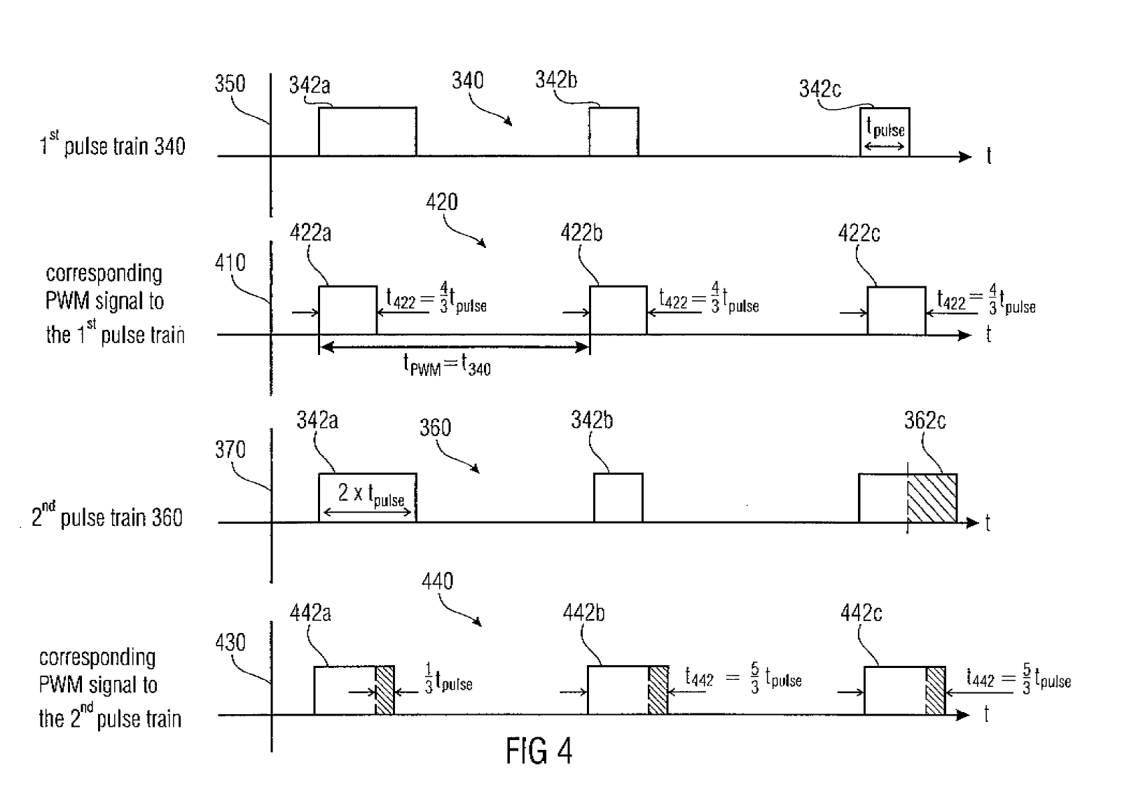

FIG. 4 shows the schematic diagram 350 of the first pulse train 340 from FIG. 3b and a schematic diagram 410 of a corresponding first PWM signal 420. Furthermore, FIG. 4b shows the schematic diagram 370 of the second pulse train 160 from FIG. 3b and a schematic diagram 430 of a corresponding second PWM signal 440. The first PWM signal 420 corresponds to the first pulse train 340, because a sum of the length of all pulses of the first pulse train 340 is the same as the sum of the length of all pulses of the first PWM signal 420. In other words, a drive signal 120 based on the first pulse train 340 would generate the same brightness at the lamp device 110 as a drive signal based on the first PWM signal 420. The first PWM signal 420 comprises three identical individual pulses 422a, 422b, 422c. A length or temporal extension of each pulse is t₄₂₂, which is a third of the pulse length tₚᵤₗₛₑ (tₚᵤₗₛₑ/3). A time t_{PWM} between two following pulses of the first PWM signal 420 is the same, as the time t₃₄₀ between two following pulses of the first pulse train 340. Therefore, the first PWM signal 420 differs from the first pulse train 340 in the fact that all pulses 422a, 422b, 422c of the first PWM signal 420 have the same length.

Analogously to the first pulse train 340 and the first PWM signal 420, the second PWM signal 440 corresponds to the second pulse train 360, because a brightness of the lamp device 110 generated by a drive signal 320 based on the second pulse train 360 is the same as the brightness generated by a drive signal based on the second PWM signal 440. As mentioned before, the second pulse train 360 differs from the first pulse train 340 by the pulse 362c, which length differs from its corresponding pulse 342c in the first pulse train 340. In the concrete embodiment shown in FIG. 4, the pulse 362c is compared to the pulse 342c extended by one pulse length tₚᵤₗₛₑ. In contrast to this, the second PWM signal 440 differs from the first PWM signal 420 in the fact that all pulses 442a, 442b, 442c are longer than their corresponding pulses 422a, 422b, 422c of the first PWM signal 420. As it can be seen from the hatched lines in the diagram 430, the pulses 442a, 442b, 442c of the second PWM signal 440 are each extended by a time, which is one-third of the pulse length tₚᵤₗₛₑ, such that a length t₄₄₂ of the three pulses 442a, 442b, 442c is four-thirds of the pulse length tₚᵤₗₛₑ (t₄₄₂=4/3*tₚᵤₗₛₑ).

An advantage of the pulse generator 330 for generating the first pulse train 340 and the second pulse train 360 compared to a conventional pulse generator for generating the first PWM signal 420 and the second PWM signal 440 is, that for a change of brightness, only a length of one pulse of a pulse train has to be changed by a certain time interval (for example, by the pulse length tₚᵤₗₛₑ) instead of changing the time of all pulses of the pulse train by a much smaller pulse length (tₚᵤₗₛₑ/3). A pulse generator 330 according to an embodiment of the present invention may, therefore, comprise a conventional microcontroller with a significantly lower instruction cycle time than a pulse generator for generating the conventional PWM signal. This leads to a significant cost reduction of the apparatus 300 compared to conventional apparatuses driving a lamp device with a conventional PWM signal.

Although amplitudes of the pulses of the pulse trains 140, 160 generated by the pulse generator 130 according to FIG. 1a are identical for the two pulse trains 140, 160, in further embodiments, the amplitude of the pulses of the first pulse train 140 may be different from the amplitude of the pulses of the second pulse train 160. Therefore, the second pulse train 160 may differ from the first pulse train 140 generated by the first pulse generator 130 not only by the frequency of the pulse trains, but also by an amplitude of the pulses of the pulse trains. For example, the amplitude of the pulses of the first pulse train 140 may be lower than the amplitude of the pulses of the second pulse train 160. According to further embodiments, this may also apply to the first pulse train 340 and the second pulse train 360 generated by the pulse generator 330 according to FIG. 3a. The first pulse train 340 generated by the pulse generator 330 may, therefore, differ from the second pulse train 360 generated by the pulse generator 330 not only by a length of pulses of the pulse trains, but also by an amplitude of the pulses of the pulse trains. For example, an amplitude of the pulses of the first pulse train 340 generated by the pulse generator 330 may be lower than an amplitude of the pulses of the second pulse train 360 generated by the pulse generator 330.

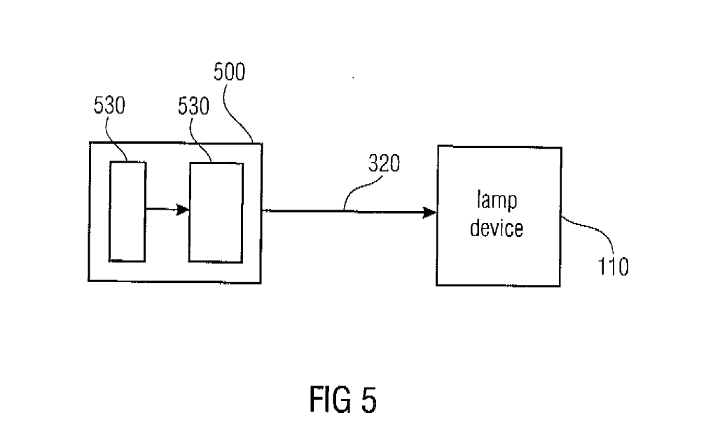

FIG. 5 shows an apparatus 500 according to an embodiment of the present invention coupled to a lamp device 110. The apparatus 500 may be the apparatus 100 according to FIG. 1a or the apparatus 300 according to FIG. 3a further comprising a brightness request generator 530 configured to provide at least the first brightness request and the second brightness request to an input terminal of a pulse generator 530 of the apparatus 500. The pulse generator 530 may, for example, be the pulse generator 130 or the pulse generator 330. The brightness request generator 590 may, for example, comprise a microcontroller or a control unit.

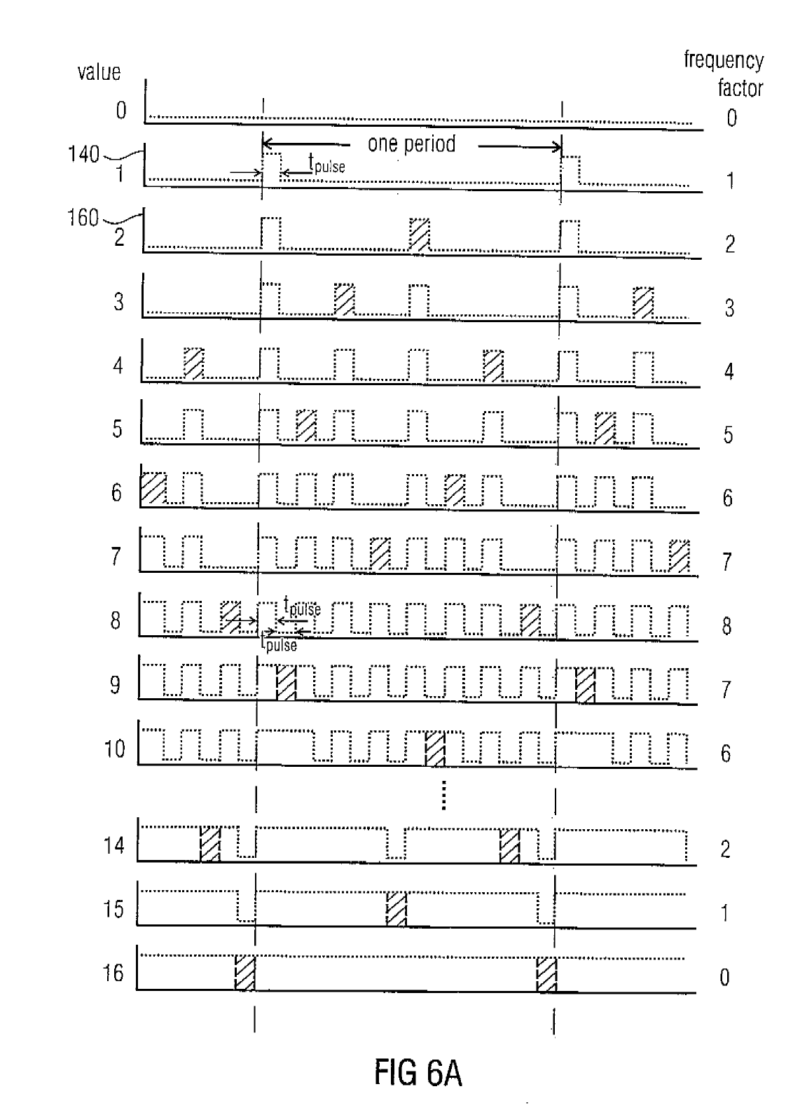

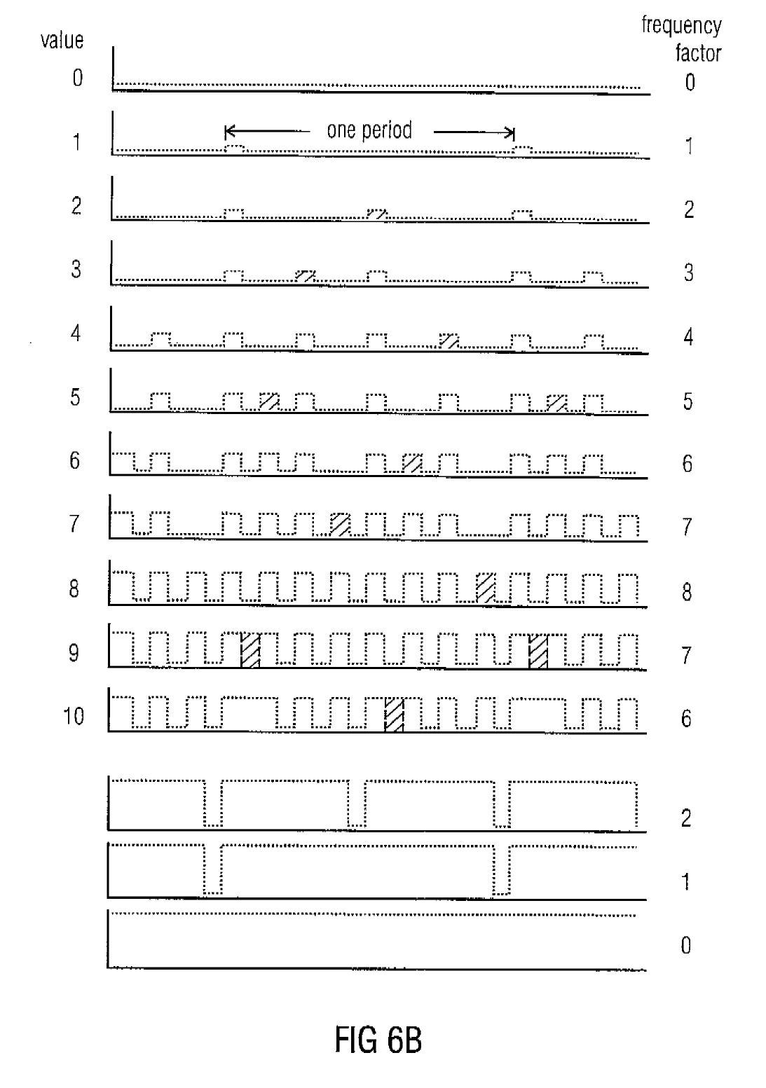

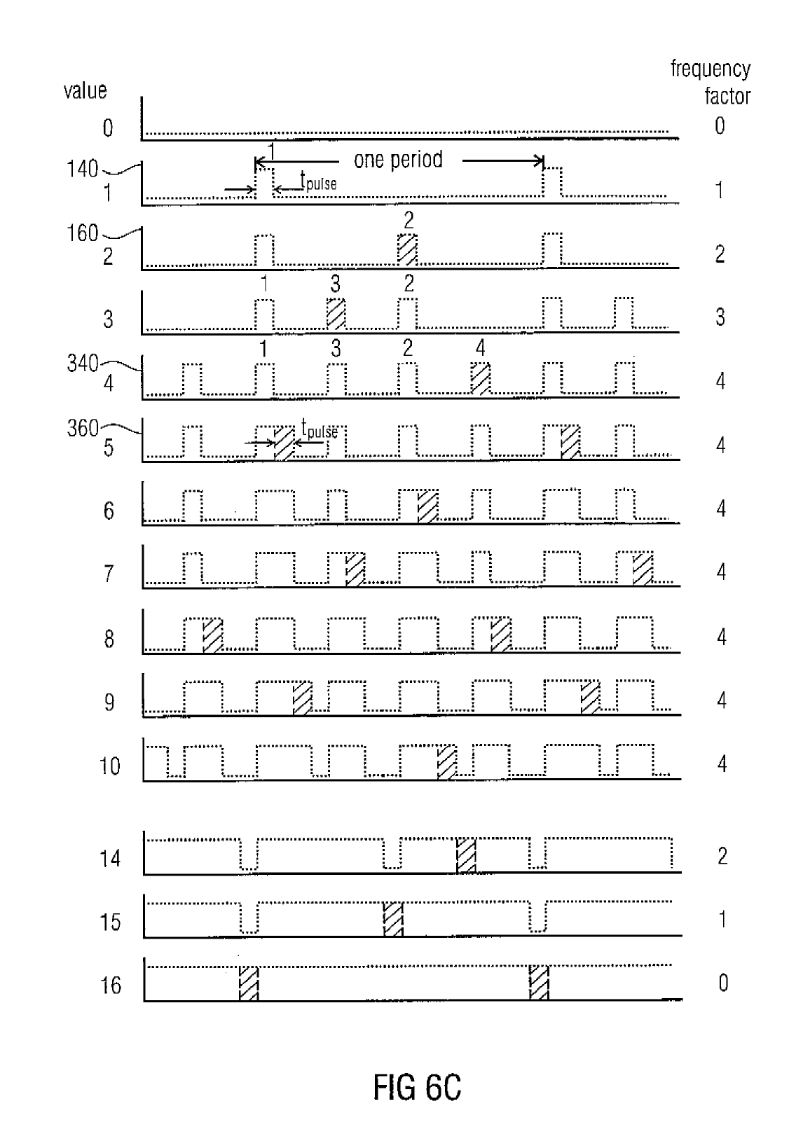

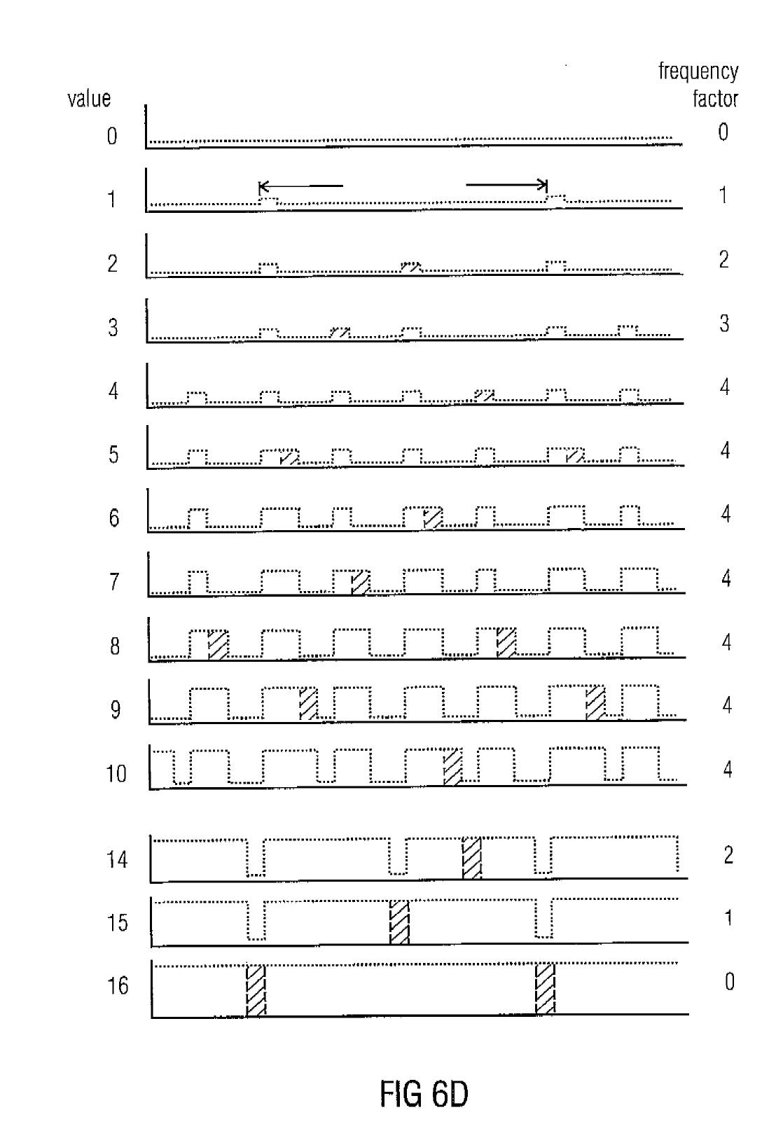

FIG. 6a shows schematic diagrams of pulse trains, for example, generated by the pulse generator 130 according to FIG. 1 as drive signals 120 for a lamp device 110. FIG. 6a shows different pulse trains for different degrees of brightness of the lamp device 110 (plus one diagram with the value 0 for an off-state of the lamp device 110). The value on the left side of the schematic diagrams designates the brightness which the corresponding pulse train generates at the lamp device 110, wherein a higher number corresponds to a higher brightness of the lamp device 110, and the value 16 corresponds to a maximum brightness of the lamp device 110. The frequency factor on the right side of the schematic diagrams designates the frequency of the corresponding pulse train, wherein a higher number designates a higher frequency of the pulse train. A pulse train shown in the second schematic diagram with a value 1 may, for example, be the first pulse train 140 and a pulse train shown in the second schematic diagram with a value 2 may, for example, be the second pulse train 160. The different pulse trains only differ from each other by the number of pulses they contain, wherein for each increase in brightness, one pulse is added, which is marked with hatched lines. Therefore, with every brightness increase, a frequency of the pulse train and of the drive signal 120 is increased until a maximum frequency is achieved. A maximum frequency is achieved at half of the brightness of the lamp device 110 (in the schematic diagram with the value 8), which is the brightness where TV cameras are most sensitive to the pulsing of the lamp device 110. As described before, a pulse length of the pulses of the pulse trains is the same for every pulse. An amplitude of the pulses in the schematic diagrams corresponds to a current, which flows through the lamp device 110 or an LED 110.

The concept of changing a frequency by adding pulses to pulse trains instead of keeping the frequency constant and extending a length of all pulses of the pulse trains reduces a frequency by a factor (for example, by a factor of 2 . . . 256). In the concrete embodiment shown in FIG. 6a, a frequency is reduced by the factor 8, which means a PWM signal corresponding to the first pulse train 140 would have 8 pulses in the one period shown in FIG. 6a, wherein a pulse length of the pulses would be one-eighth of tₚᵤₗₛₑ. It has been shown that a frequency factor of 16 is a good compromise. The concept shown is based on the fact that not one pulse with a variable length is used, like in the conventional PWM concept, but pulses are added based on the brightness. These pulses are added based on a binary concept. In the concept shown in FIG. 6a, a maximum frequency is not limited. The frequency is always dependent from the brightness, vice-versa, the brightness is always dependent on the frequency of a pulse train or the drive signal 120. A maximum frequency is achieved at half the brightness of the lamp device 110. By using this concept shown in FIG. 6a, high frequencies can be achieved, especially at the critical degrees of brightness around 50% of the lamp device 110, wherein cameras, like HDTV cameras, react most sensitively.

At the maximum frequency (value 8 in FIG. 6a), a time between two rising edges of two temporally-following pulses is the same as the pulse length tₚᵤₗₛₑ of the pulses. A frequency of the drive signal 120 may, at the half of the maximum brightness of the lamp device 110, be the same as the frequency of a corresponding conventional PWM signal.

If the brightness of the lamp device 110 should be further increased above half of the maximum brightness of the lamp device 110, further pulses are added and, therefore, a frequency of the drive signal 120 is lowered, but which does not have negative consequences, because HDTV cameras, as mentioned above, react most critically at half of the maximum brightness of the lamp device 110.

By choosing the frequency and by having longer pulse lengths than conventional PWM signals, a pulse generator 130 and, therefore, an apparatus 100 can be less sophisticated than a pulse generator needed for generating a conventional PWM signal for driving the lamp device 110 fulfilling the same requirements, like the pulse generator 130.

FIG. 6b shows the schematic diagrams of FIG. 6a, but wherein the different pulse trains for the different degrees of brightness not only differ by the number of pulses they contain, but also by the amplitude of the pulses thereof. In other words, with the shown concept in FIG. 6b, not only the number of pulses is changed, but, at the same time, an amplitude of the pulses (for example, a current flowing into the lamp device 110) is changed. This means that at the beginning when a low brightness is required, pulses with a very small current amplitude are generated by the pulse generator 130 provided to the lamp device 110. The amplitude (the current amplitude) of all pulses may be increased linearly from 0% to 100% (for example, with every increase infrequency). In the concrete embodiment shown in FIG. 6b, an amplitude of the pulses of the first pulse train (value 1) may be one-sixteenth of the amplitude of the pulses of the 16^{th} pulse train (value 16). This concept has the advantage that very small degrees of brightness can be adjusted soft and stepless (or at least nearly stepless or continuous). Furthermore, at the beginning (for small values shown in FIG. 6b) drive signals based on the pulse trains with low frequencies have the lowest amplitudes and, therefore, very low degrees of brightness. This is advantageous, because as mentioned before, a camera like an HDTV camera shows a pulsing if a frequency of a drive signal of a lamp device is too low, only with higher degrees of brightness. An amplitude of the pulses may be adjusted by a digital to analog converter of the pulse generator 130, wherein the pulse generator 130 may, for example, be a conventional microcontroller.

FIG. 6c shows schematic diagrams of drive signals with different pulse trains for different degrees of brightness for a lamp device 110. The pulse trains shown in FIG. 6c differ from the pulse train shown in FIG. 6a in the fact that a maximum frequency of the pulse trains is limited (in the concrete embodiment shown in FIG. 6c to a frequency factor of 4) and when a maximum frequency of the pulse trains is reached, no further individual pulses are added, but a length of the pulses of the pulse trains is changed to further increase the brightness of the lamp device 110. The pulse generator generating the pulse trains shown in FIG. 6c may, therefore, be a combination out of the pulse generator 130 according to FIG. 1a and the pulse generator 330 according to FIG. 3a. In FIG. 6c, the first four pulse trains (value 1 to value 4) differ by the number of pulses they contain. Beginning from the fifth pulse train, the pulse trains differ by the length of the pulses they contain. A length of the pulses is not extended continually. This means that the pulses are always extended by a pulse length tₚᵤₗₛₑ of the pulse of the first pulse train with a value 1. The first pulse train with the value 1 may, for example, be the first pulse train 140 according to FIG. 1b. The second pulse train with the value 2 may, for example, be the second pulse train 160 according to FIG. 1b. The fourth pulse train (value 4) may, for example, be the first pulse train 340 according to FIG. 3b. The fifth pulse train (value 5) may, for example, be the second pulse train 360 according to FIG. 3b.

The concept shown in FIG. 6c reduces the frequency of the drive signal by a factor 2 . . . 256 compared to conventional PWM signals. For simplicity reasons, in FIG. 6c, a reduction of the frequency factor 4 is shown. As mentioned before, it has been shown that a frequency factor of 16 is a good compromise. The concept is based on this, that not one pulse with a variable length (PWM) is used, but instead several pulses are added, based on a required brightness. These pulses are added based on a binary method. As soon as, for example, sixteen pulses for a factor of 16 or four pulses for a factor of 4 are contained in a pulse train, for a further increase of the brightness, the length of the pulses are increased based on the same binary method. In this method, the frequency is raised, for example, until sixteen pulses or, in the concrete embodiment shown in FIG. 2c, four pulses for a period are provided. After this (beginning with the fifth pulse train with a value of 5), for a further brightness increase, the frequency is, furthermore, not raised. Instead, the pulse lengths from pulse-to-pulse are extended (which means the pulse lengths of the pulses contained in the pulse trains are extended). The pulse lengths of the pulses may not be continuously extended, but in steps of the length (tₚᵤₗₛₑ) of the first pulse of the first pulse train.

For example, if a first pulse of the first pulse train has a pulse length of 1 ms, after fifteen further pulses have been added for a factor of 16 (in the concrete embodiment shown in FIG. 6c for a factor of 4, after three further pulses have been added) the first pulse is extended to 2 ms (its pulse length is increased to 2 ms). If then all sixteen pulses (in the concrete embodiment shown in FIG. 6c, after all four pulses) are extended to 2 ms, then the first pulse is extended to 3 ms and ongoing, until the drive signal is a continuous high signal (value 16 in FIG. 6c).

FIG. 6d shows a schematic diagram from FIG. 6c with the difference that with a brightness increase, not only the frequency of the drive signal is raised or the length of the pulses is extended, but also an amplitude of the pulses of the pulse trains is changed. This is analog to FIG. 6b and offers the same advantages, as already described in FIG. 6d.

The four concepts shown of the FIGS. 6a to 6d differ in different aspects from the conventional PWM signal. A conventional PWM signal has a constant frequency, wherein a pulse-pause ratio is changed (for example, continuously changed). Furthermore, an amplitude of the pulses of the PWM signal is constant.

In contrast to this, the concepts or methods described herein have a changeable frequency and/or pulses are added in discrete length. Within the drive signals based on pulse trains shown in FIGS. 6a to 6d, a length of the pulses in a base period of the drive signal may be different at arbitrary places within the base period. Additionally, an amplitude of the pulses may be varied.

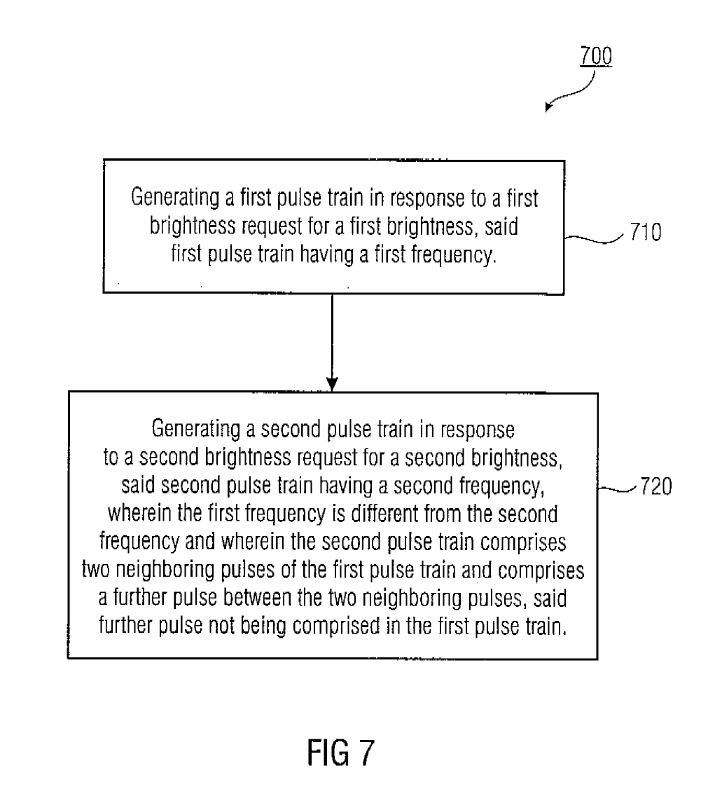

FIG. 7 shows a flow diagram of a method 700 for generating a drive signal for a lamp device. The method 700 comprises a step 710 of generating a first pulse train in response to a first brightness request for a first brightness. The first pulse train has a first frequency.

Furthermore, the method 700 comprises a step 720 of generating a second pulse train in response to a second brightness request for a second brightness. The second pulse train has a second frequency, wherein the first frequency of the first pulse train is different from the second frequency of the second pulse train. The second pulse train further comprises two neighboring pulses of the first pulse train and comprises a further pulse between the two neighboring pulses. The further pulse of the second pulse train is not comprised in the first pulse train.

According to further embodiments, the method 700 may comprise a step of receiving a first brightness request before the step 710 of generating the first pulse train. Furthermore, the method 700 may comprise a step of receiving the second brightness request before the step 720 of generating the second pulse train.

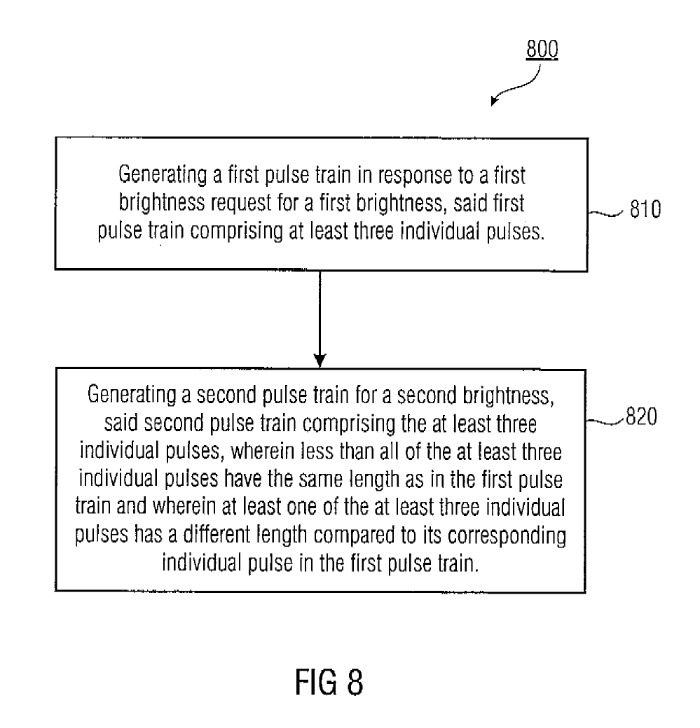

FIG. 8 shows a flow diagram of a method 800 for generating a drive signal for a lamp device. The method 800 comprises a step 810 of generating a first pulse train in response to a first brightness request for a first brightness. The first pulse train comprises at least three individual pulses.

Furthermore, the method 800 comprises a step 820 of generating a second pulse train for a second brightness. The second pulse train comprises at least the three individual pulses of the first pulse train. Less than all of the at least three individual pulses of the second pulse train have the same length as in the first pulse train and at least one of the at least three individual pulses of the second pulse train has a different length compared to its corresponding individual pulse in the first pulse train.

According to further embodiments, the method 800 may comprise a step of receiving the first brightness request before the step 810 of generating the first pulse train. Furthermore, the method 800 may comprise a step of receiving the second brightness request before the step 820 of generating the second pulse train.

The methods 700 and 800 may be supplemented by any features or functions of the apparatus as described before.

The concept described herein of providing a drive signal for a lamp device has several advantageous features compared to conventional PWM concepts.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

1. Apparatus (100) for generating a drive signal (120) for a lamp device (110), the apparatus (100) comprising:
a pulse generator (130) for generating a first pulse train (140) in response to a first brightness request for a first brightness, said first pulse train (140) having a first frequency; and
for generating a second pulse train (160) in response to a second brightness request for a second brightness, said second pulse train (160) having a second frequency;
wherein the first frequency is different from the second frequency; and
wherein the second pulse train (160) comprises two neighboring pulses (142a, 142b) of the first pulse train (140) and comprises a further pulse (162c) between the two neighboring pulses (142a, 142b), said further pulse (162c) not being comprised in the first pulse train (140).

2. The apparatus (100) according to claim 1, wherein the pulse generator (130) is configured to generate the first pulse train (140) and the second pulse train (160) such that a pulse length (tₚᵤₗₛₑ) of the two neighboring pulses (142a, 142b) and of the further pulse (162a) is identical.

3. The apparatus (100) according to claim 1, wherein the second brightness is brighter than the first brightness.

4. The apparatus according (100) to claim 1, further comprising a brightness request generator (130) configured to provide at least a first brightness request and a second brightness request to an input terminal of the pulse generator (130).

5. The apparatus (100) according to claim 1, wherein the pulse generator (130) is configured to generate the first pulse train (140) and the second pulse train (160) such that a temporal extension of the first pulse train (140) and a temporal extension of the second pulse train (160) are identical.

6. The apparatus (100) according to claim 1, wherein the pulse generator (130) is configured to generate the second pulse train (160) such that a time between a falling edge of a first pulse (142a) of the two neighboring pulses (142a, 142b), and a rising edge of the further pulse (162a) is the same like a pulse length of one of the neighboring pulses (142a, 142b) or the further pulse (162a), or is a multiple of a pulse length of one of the neighboring pulses (142a, 142b) or the further pulse (162a).

7. The apparatus (100) according to claim 1, wherein the pulse generator (130) is configured to generate the second pulse train (160) such that a first time between a falling edge of a first pulse (142a) of the two neighboring pulses (142a, 142b) and a rising edge of the further pulse (162a) is the same as a second time between a falling edge of the further pulse (162a) and a rising edge of a second pulse (142b) of the two neighboring pulses (142a, 142b).

8. The apparatus (100) according to claim 1, wherein the pulse generator (130) is configured to generate the first pulse train (140) and the second pulse train (160) such that a first amplitude of pulses of the first pulse train (140) is identical, such that a second amplitude of pulses of the second pulse train (160) is identical and such that the first amplitude is lower than the second amplitude.

9. The apparatus (100, 500) according to claim 1, further comprising a brightness request generator (590) configured to provide at least a first brightness request and a second brightness request to an input terminal of the pulse generator (130).

10. The apparatus (100) according to claim 1, wherein the pulse generator (130) is configured to generate a plurality of different pulse trains in response to a plurality of different brightness requests such that a pulse train out of the plurality of pulse trains corresponds to a brightness request out of the plurality of brightness requests and such that the plurality of pulse trains differ from each other by the number of pulses they comprise.

11. The apparatus (100) according to claim 10, wherein the pulse generator (130) is configured to generate the plurality of different pulse trains such that the plurality of different pulse trains differ further from each other by an amplitude of the pulses they comprise.

12. Apparatus (300) for generating a drive signal (320) for a lamp device (110), the apparatus (300) comprising:
a pulse generator (330) for generating a first pulse train (340) in response to a first brightness request for a first brightness, said first pulse train (340) comprising at least three individual pulses (342a, 342b, 342c); and
for generating a second pulse train (360) in response to a second brightness request for a second brightness, said second pulse train (360) comprising the at least three individual pulses (342a, 342b, 362c), wherein less than all of the at least three individual pulses (342a, 342b, 362c) have the same length than in the first pulse train (340) and at least one pulse (362c) of the at least three individual pulses (342a, 342b, 362c) has a different length compared to the corresponding individual pulse (342c) in the first pulse train (340).

13. The apparatus (300) according to claim 12, wherein the pulse generator (330) is configured to generate the first pulse train (340) and the second pulse train (360) such that the length of the at least three individual pulses (342a, 342b, 342c) of the first pulse train (340) is a multiple of a smallest pulse length (tₚᵤₗₛₑ) or is the smallest pulse length (tₚᵤₗₛₑ) and such that the at least one pulse (362c) of the at least three individual pulses (342a, 342b, 362c) of the second pulse train (360), having the different length compared to its corresponding individual pulse (342c) in the first pulse train (340), differs to its corresponding individual pulse (342c) in the first pulse train (340) by a multiply of the smallest pulse length (tₚᵤₗₛₑ) or by the smallest pulse length (tₚᵤₗₛₑ).

14. The apparatus (300) according to claim 12, wherein the pulse generator (330) is configured to generate the first pulse train (340) and the second pulse train (360) such that a length of the three individual pulses is identical or such that a first length of one of the three individual pulses differs by the smallest pulse length to a second length of the other two pulses of the three individual pulses.

15. The apparatus (300, 500) according to claim 12, further comprising a brightness request generator (590) configured to provide at least a first brightness request and a second brightness request to an input terminal of the pulse generator (330).

16. The apparatus (300) according to claim 12, wherein the pulse generator (330) is configured to generate the first pulse train (340) and the second pulse train (360) such that a first amplitude of pulses of the first pulse train (340) is identical, such that a second amplitude of pulses of the second pulse train (360) is identical and such that the first amplitude is lower than the second amplitude.

17. The apparatus (300) according to claim 12, wherein the pulse generator (330) is configured to generate a plurality of different pulse trains in response to a plurality of different brightness requests such that a pulse train out of the plurality of pulse trains corresponds to a brightness request out of the plurality of brightness requests and such that the plurality of pulse trains differ from each other by a length of at least one pulse they comprise.

18. The apparatus (300) according to claim 17, wherein the pulse generator (330) is configured to generate the plurality of different pulse trains such that the plurality of different pulse trains further differ from each other by an amplitude of the pulses they comprise.

19. A method (700) for generating a drive signal for a lamp device with:
generating a first pulse train in response to a first brightness request for a first brightness, said first pulse train having a first frequency; and
generating a second pulse train in response to a second brightness request for a second brightness, said second pulse train having a second frequency, wherein the first frequency is different from the second frequency and wherein the second pulse train comprises two neighboring pulses of the first pulse train and comprises a further pulse between the two neighboring pulses, said further pulse not being comprised in the first pulse train.

20. A method (800) for generating a drive signal for a lamp device with:
generating a first pulse train in response to a first brightness request for a first brightness, said first pulse train comprising at least three individual pulses; and
generating a second pulse train for a second brightness, said second pulse train comprising the at least three individual pulses, wherein less than all of the at least three individual pulses have the same length as in the first pulse train and wherein at least one of the at least three individual pulses has a different length compared to its corresponding individual pulse in the first pulse train.

21. A tangible computer readable medium including a computer program including program code for carrying out, when the computer program is executed on a computer, the method according to claim 19.

22. A tangible computer readable medium including a computer program including program code for carrying out, when the computer program is executed on a computer, the method according to claim 20.
